(19) United States
(12) Patent Application Publication
(10) Pub. No.: US 2015/0061236 A1
(43) Pub. Date: Mar. 5, 2015

(54) SOLDERED MACHINING TOOL AND SOLDERED BAR STOCK FOR FORMING THE SOLDERED MACHINING TOOL

(71) Applicant: Topgreen Technology Co., Ltd., New Taipei City (TW)

(72) Inventor: Ping-Da Lin, New Taipei City (TW)

(73) Assignee: Topgreen Technology Co., Ltd., New Taipei City (TW)

(21) Appl. No.: 14/015,097

(22) Filed: Aug. 30, 2013

(51) Int. Cl. B23B 27/18

(52) U.S. Cl. CPC B23B 27/18; B23B 2231/0204; B23B 2240/11
USPC 279/105

(57) ABSTRACT

A soldered bar stock has a handle blank with a first through hole, and has a head blank having a soldered portion protruding into and soldered in the first through hole. The soldered bar stock is machined to form a soldered machining tool. With the first through hole formed in the handle blank, the head blank can be firmly soldered to the handle blank. When replacing the head blank with a new one, solder in the first through hole can be completely cleaned. Moreover, when using the soldered machining tool, a cooling liquid can be injected into the first through hole to cool down the soldered machining tool.

### BACKGROUND OF THE INVENTION

1. Field of the Invention

The present invention relates to a soldered machining tool that is used for milling, drilling, boring, or tapping thread, and also relates to a soldered bar stock that is used for forming the soldered machining tool.

2. Description of the Prior Art(s)

Heads of machining tools are formed into different shapes according to functions of the machining tools. For example, a machining tool with a pointed head is used to drill holes on a workpiece. In addition, a machining tool with a flat head is used to mill the workpiece or to tap threads in the holes of the workpiece.

A conventional machining tool has a clamping handle and a shank. The clamping handle may be made of stainless steel, carbon steel, or tungsten steel. The clamping handle has a recess formed in an end surface of the clamping handle. The shank may be made of tungsten steel and has a head formed on a front end of the shank. When assembling the shank to the clamping handle, the clamping handle is pre-heated to enlarge the recess of the clamping handle. Then a rear end of the shank is mounted into the recess of the clamping handle. As the clamping handle cools down, the recess of the clamping handle is reduced. Accordingly, the rear end of the shank is tightly fitted in the recess of the clamping handle.

In use, the clamping handle of the conventional machining tool is mounted in and clamped by a chuck of a processing machine, and the head of the shank is aimed at a workpiece. When the clamping handle as well as the shank is rotated with the chuck, the head of the shank mills the workpiece or drills holes on the workpiece.

However, when rotating in high speed and milling or drilling the workpiece, the conventional machining tool bears high torque. Since the shank is merely fitted tightly in the clamping handle, the shank breaks easily, especially at a connection junction where the shank and the clamping handle connect to each other. As the conventional machining tool wears and tears easily, qualities of milling or drilling with the conventional machining tool are low, and danger of using the conventional machining tool is high.

To overcome the shortcomings, the present invention provides a soldered machining tool and a soldered bar stock for forming the soldered machining tool to mitigate or obviate the aforementioned problems.

### SUMMARY OF THE INVENTION

The main objective of the present invention is to provide a soldered machining tool and a soldered bar stock for forming the soldered machining tool. The soldered bar stock has a handle blank and a head blank. The handle blank has a first through hole axially formed through the handle blank. The head blank has a soldered portion protruding into the first through hole and is soldered to the handle blank. The soldered bar stock is machined to form the soldered machining tool. The soldered machining tool has a handle formed by machining the head blank, and has a head formed by machining the head blank.

With the first through hole formed in the handle blank, the head blank can be firmly soldered to the handle blank. When replacing the head blank with a new one, solder in the first through hole can be completely cleaned. Moreover, when using the soldered machining tool, a cooling liquid can be injected into the first through hole to cool down the soldered machining tool.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a soldered bar stock in accordance with the present invention;

FIG. 2 is a cross-sectional side view of the first embodiment of the bar stock in FIG. 1;

FIG. 3 is an exploded perspective view of a first embodiment of a soldered machining tool in accordance with the present invention, wherein the first embodiment of the soldered machining tool is formed by machining the first embodiment of the bar stock in FIG. 1;

FIG. 4 is a side view in partial section of the first embodiment of the soldered machining tool in FIG. 3;

FIG. 5 is an exploded perspective view of a second embodiment of a soldered bar stock in accordance with the present invention;

FIG. 6 is a cross-sectional side view of the second embodiment of the bar stock in FIG. 5;

FIG. 7 is a side view in partial section of a second embodiment of a soldered machining tool in accordance with the present invention;

FIG. 8 is an exploded perspective view of a third embodiment of a soldered bar stock in accordance with the present invention;

FIG. 9 is a cross-sectional side view of the third embodiment of the bar stock in FIG. 8;

FIG. 10 is a side view in partial section of a third embodiment of a soldered machining tool in accordance with the present invention, wherein the third embodiment of the soldered machining tool is formed by machining the third embodiment of the bar stock in FIG. 8;

FIG. 11 is an exploded perspective view of a fourth embodiment of a soldered bar stock in accordance with the present invention;

FIG. 12 is a cross-sectional side view of the fourth embodiment of the bar stock in FIG. 11; and

FIG. 13 is a side view in partial section of a fourth embodiment of a soldered machining tool in accordance with the present invention, wherein the fourth embodiment of the soldered machining tool is formed by machining the fourth embodiment of the bar stock in FIG. 11.

### DETAILED DESCRIPTION OF THE PREFERRED EMBODIMENTS

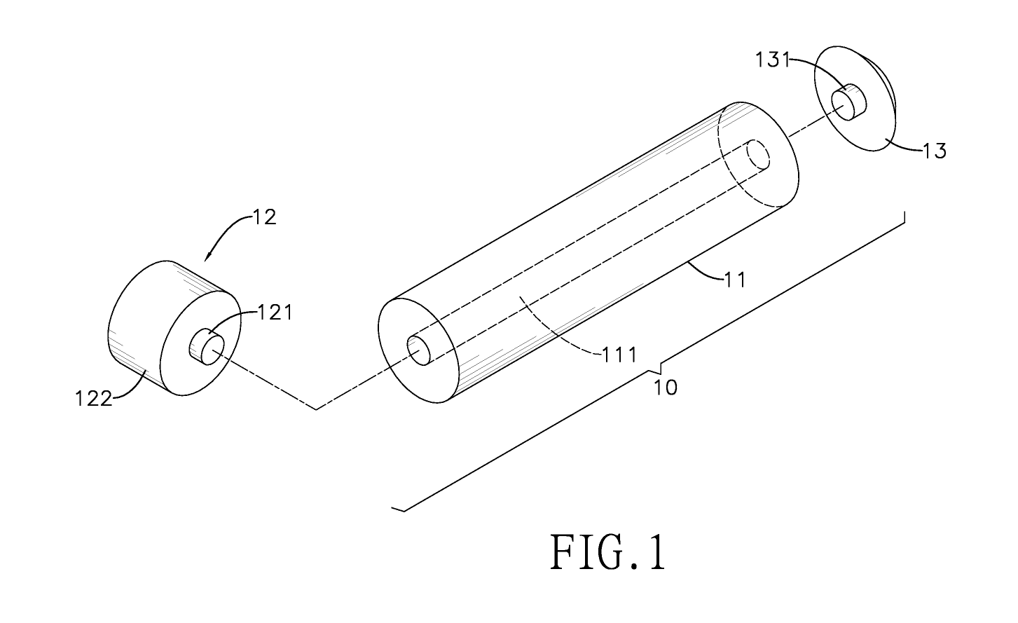

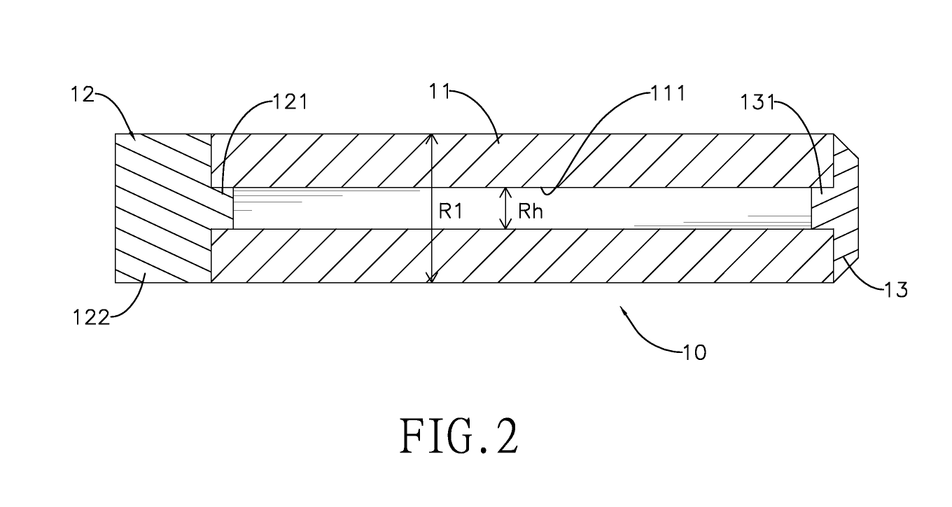

With reference to FIGS. 1 and 2, a first preferred embodiment of a soldered bar stock 10 in accordance with the present invention comprises a handle blank 11, a head blank 12, and an end cap 13.

The handle blank 11 is cylindrical, may be made of stainless steel, carbon steel, or tungsten steel, and has a front end surface, a rear end surface, and a first through hole 111. The first through hole 111 is axially formed in the handle blank 11 and through the front end surface and the rear end surface of the handle blank 11. Preferably, a diameter Rh of the first through hole 111 is one fourth to one half of a diameter R1 of the handle blank 11.

The head blank 12 is securely mounted on the front end surface of the handle blank 11, may be made of high hardness materials such as tungsten steel, polycrystalline diamond (PCD), cubic boron nitride (CBN), ceramic or the like, and has a pre-machining portion 122 and a soldered portion 121. The pre-machining portion 122 is cylindrical and has a rear end surface. The rear end surface of the pre-machining portion 122 corresponds to the front end surface of the handle blank 11. The soldered portion 121 is formed on and protrudes from the rear end surface of the pre-machining portion 122, is mounted into the first through hole 111 of the handle blank 11, and is soldered to the handle blank 11.

The end cap 13 is mounted on the rear end surface of the handle blank 11 and has an end surface and a connecting protrusion 131. The end surface of the end cap 13 corresponds to the rear end surface of the handle blank 11. The connecting protrusion 131 is formed on and protrudes from the end surface of the end cap 13, is mounted into the first through hole 111 of the handle blank 11, and is tightly fitted in the handle blank 11.

Specifically, the handle blank 11 and the pre-machining portion 122 are circular in cross-section. The first through hole 111 of the handle blank 11 is circular in cross-section. The soldered portion 121 of the head blank 12 and the connecting protrusion 131 of the end cap 13 correspond to the first through hole 111 of the handle blank 11 and are also circular in cross-section. Alternatively, the handle blank 11 and the pre-machining portion 122 may be polygonal in cross-section. The first through hole 111 of the handle blank 11 may be polygonal in cross-section. The soldered portion 121 of the head blank 12 and the connecting protrusion 131 of the end cap 13 correspond to the first through hole 111 of the handle blank 11 and may also be polygonal in cross-section.

The above-mentioned soldered bar stock 10 may be machined to form a soldered machining tool. A diameter of the soldered portion 121 of the head blank 12 and a proportion of a length of the handle blank 11 to a length of the head blank 12 are decided according to types of the soldered machining tool. The soldered machining tool may be a drill bit or a milling cutter.

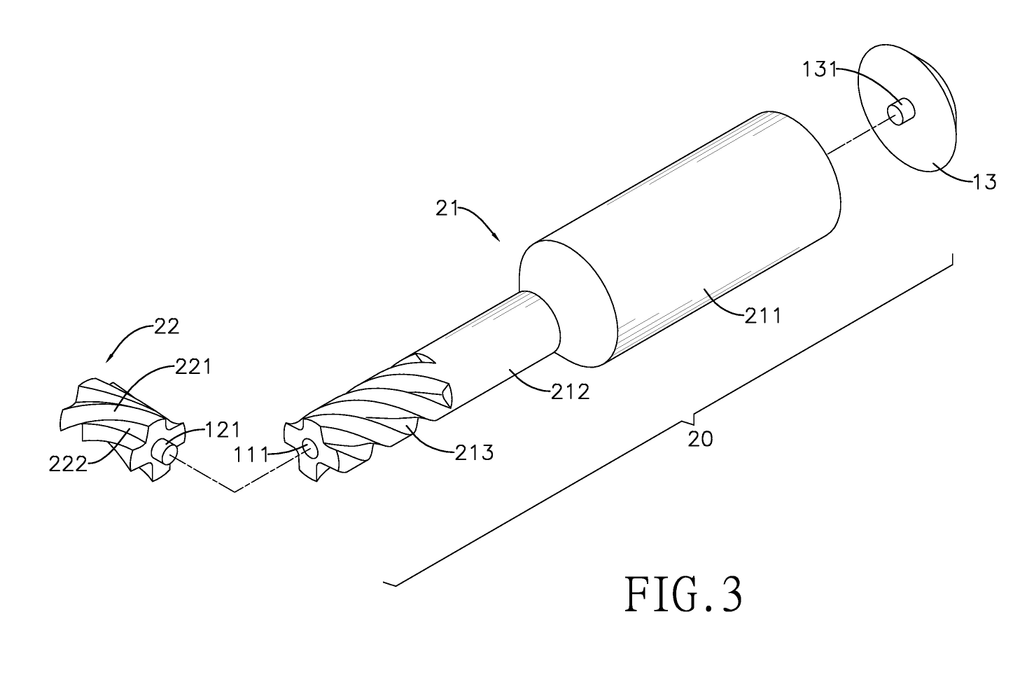

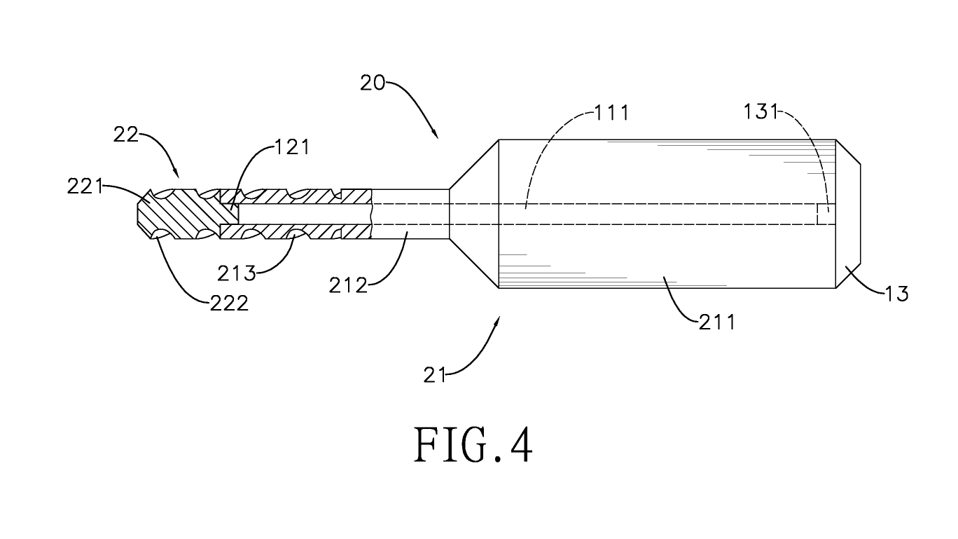

With further reference to FIGS. 3 and 4, a first preferred embodiment of a soldered machining tool 20 in accordance with the present invention is formed by machining the above-mentioned first preferred embodiment of the soldered bar stock 10. The first preferred embodiment of the soldered machining tool 20 comprises a handle 21, a head 22 and the end cap 13.

The handle 21 is formed by machining the handle blank 11 and has a clamping portion 211, a shank 212, multiple helical grooves 213, a front end surface, and a rear end surface. The clamping portion 211 has a front end and a rear end. The shank 212 axially protrudes from the front end of the clamping portion 211 and has an outer surface and a distal end. The front end surface of the handle 21 is defined on the distal end of the shank 212. The rear end surface of the handle 21 is defined on the rear end of the clamping portion 211. A diameter of the shank 212 is shorter than a diameter of the clamping portion 211. The helical grooves 213 of the handle 21 are formed on the outer surface of the shank 212. The first through hole 111 is axially defined through the clamping portion 211 and the shank 212 of the handle 21.

The head 22 is formed by machining the pre-machining portion 122 of the head blank 12, is securely mounted on the front end surface of the handle 21, is securely mounted on the distal end of the shank 212 of the handle 21, and has a machining portion 221, multiple helical grooves 222, and the soldered portion 121. The machining portion 221 has an outer surface and a rear end surface. The rear end surface of the machining portion 221 corresponds to the front end surface of the handle 21 and corresponds to the distal end of the shank 212 of the handle 21. The helical grooves 222 of the head 22 are formed on the outer surface of the machining portion 221 and respectively communicate with the helical grooves 213 of the handle 21. The soldered portion 121 of the head blank 12 is defined on the rear end surface of the machining portion 221 of the head 22, is mounted into the first through hole 111 of the handle 21, and is soldered to the handle 21.

The end cap 13 is mounted on the rear end surface of the handle 21, and is mounted on the rear end of the clamping portion 211 of the handle 21. The connecting protrusion 131 of the end cap 13 is mounted into the first through hole 111 of the handle 21 and is tightly fitted in the handle 21.

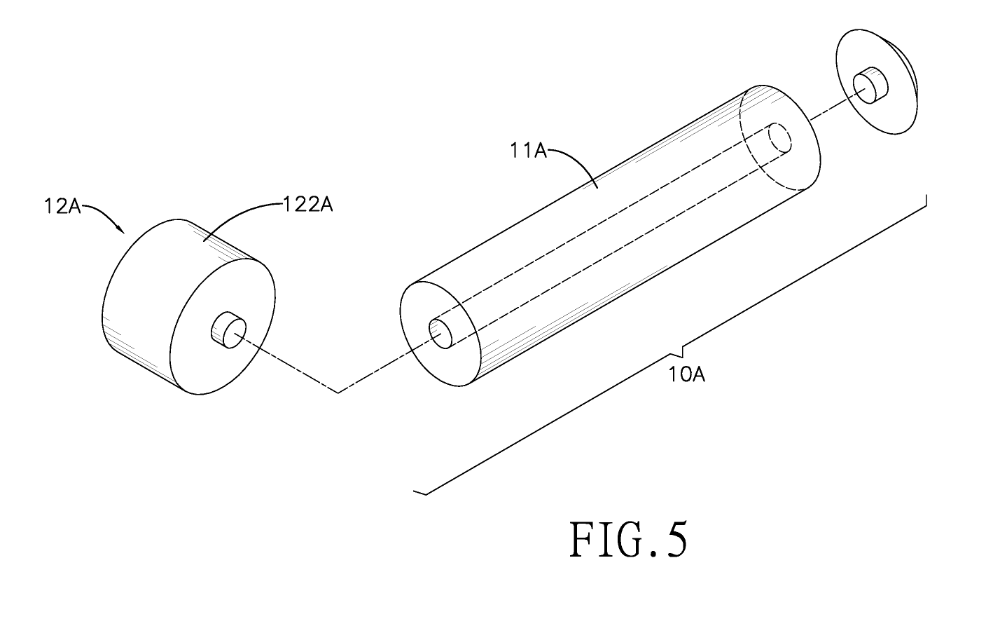

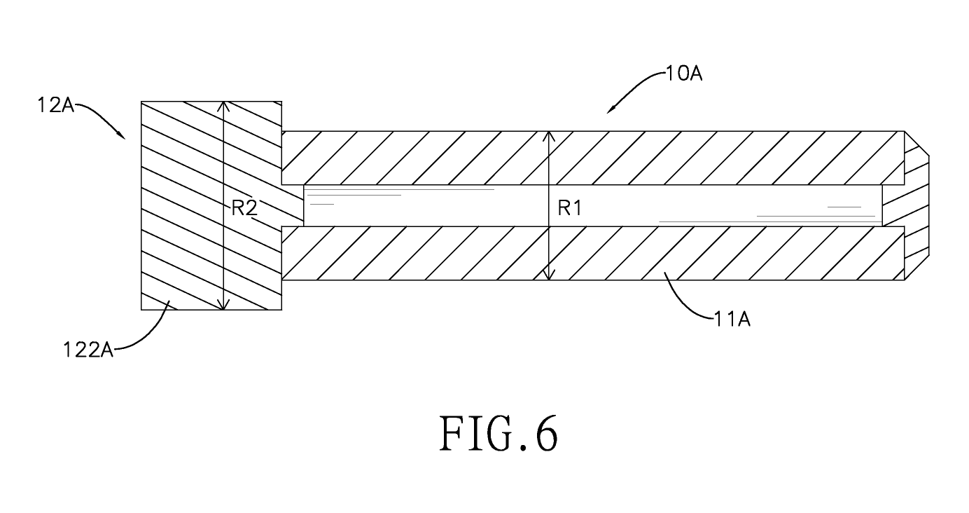

With reference to FIGS. 5 and 6, in a second preferred embodiment of a soldered bar stock 10A in accordance with the present invention, a diameter R2 of the pre-machining portion 122A of the head blank 12A is different from the diameter R1 of the handle blank 11A. Specifically, the diameter R2 of the head blank 12A may be longer than the diameter R1 of the handle blank 11A.

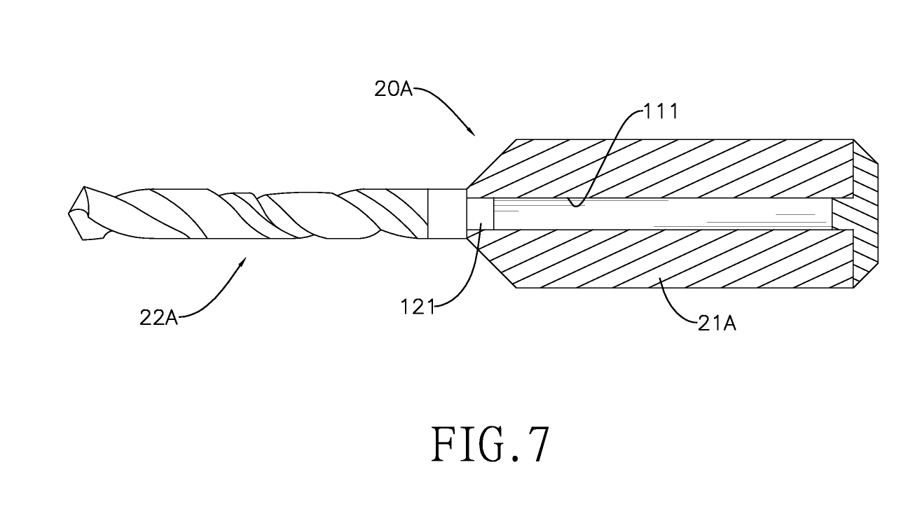

With reference to FIG. 7, in a second preferred embodiment of a soldered machining tool 20A in accordance with the present invention, the head 22A is elongated and has a length that approximates a length of the handle 21A.

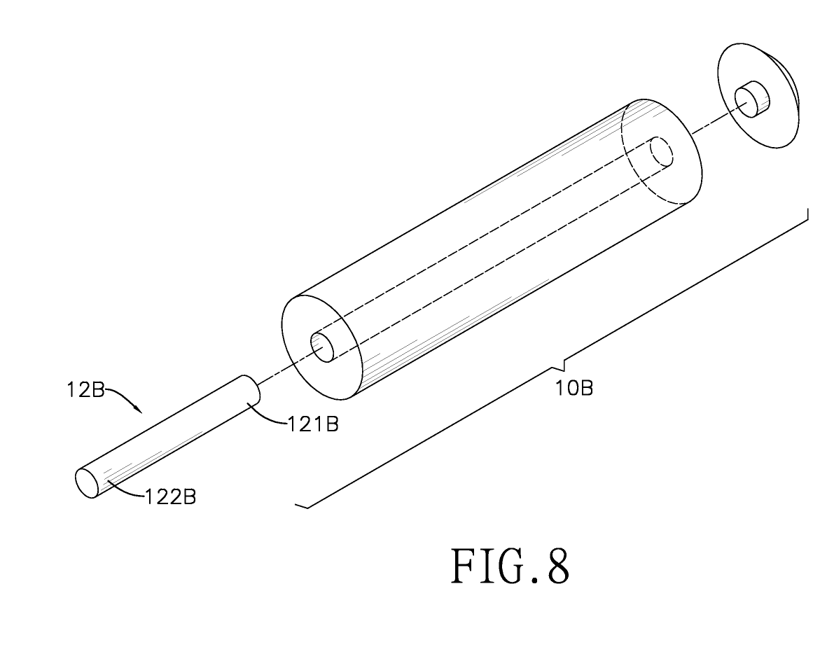

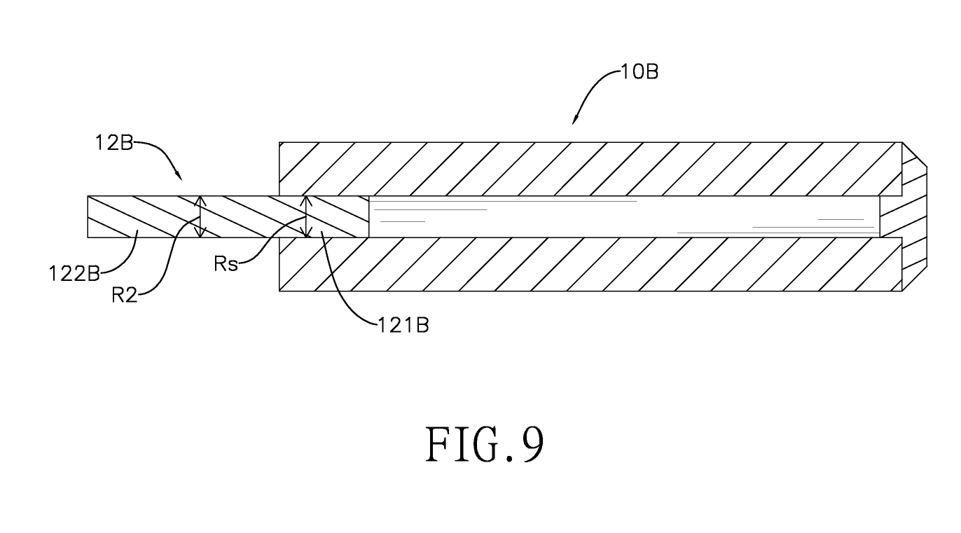

With reference to FIGS. 8 and 9, in a third preferred embodiment of a soldered bar stock 10B in accordance with the present invention, the head blank 12B has a uniform diameter. The diameter R2 of the pre-machining portion 122B of the head blank 12B is equal to a diameter Rs of the soldered portion 121B of the head blank 12B.

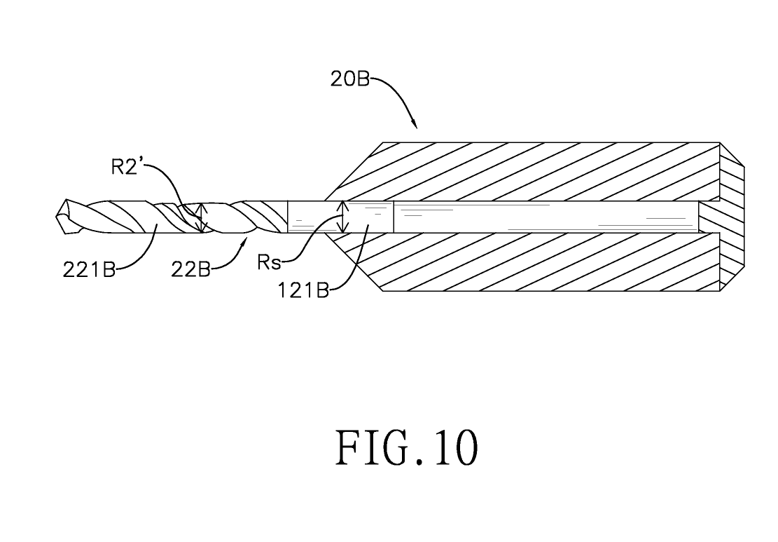

With further reference to FIG. 10, a third preferred embodiment of a soldered machining tool 20B in accordance with the present invention is formed by machining the above-mentioned third preferred embodiment of the soldered bar stock 10B. The pre-machining portion 122B of the head blank 12B of the soldered bar stock 10B is machined to form the machining portion 221B of the head 22B of the soldered machining tool 20B. An outer diameter R2′ of the machining portion 221B is equal to the diameter Rs of the soldered portion 121B of the head 22B. Accordingly, the head 22B has a uniform diameter.

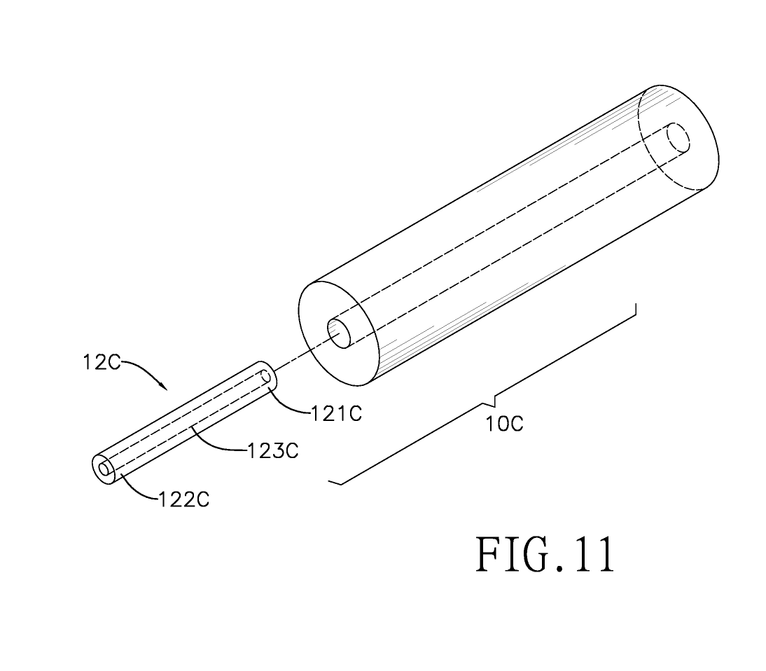

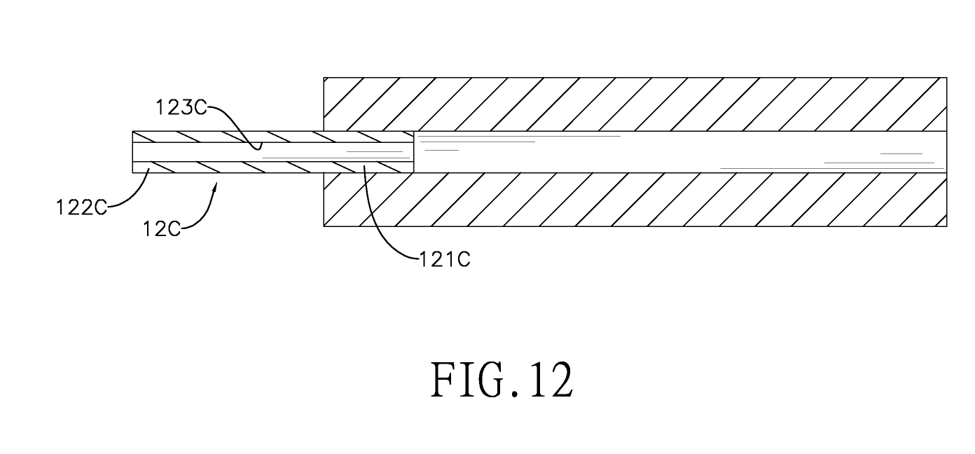

With reference to FIGS. 11 and 12, in a fourth preferred embodiment of a soldered bar stock 10C in accordance with the present invention, the head blank 12C further has a second through hole 123C. The second through hole 123C is axially formed through the head blank 12C.

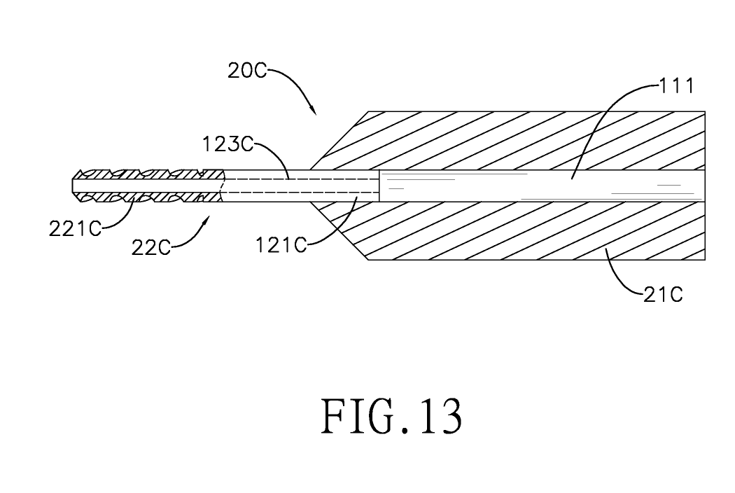

With further reference to FIG. 13, a fourth preferred embodiment of a soldered machining tool 20C in accordance with the present invention is formed by machining the above-mentioned fourth preferred embodiment of the soldered bar stock 10C. The pre-machining portion 122C of the head blank 12C of the soldered bar stock 10C is machined to form the machining portion 221C of the head 22C of the soldered machining tool 20C. The second through hole 123C is defined in the machining portion 221C and the soldered portion 121C of the head 22C.

The soldered machining tool 20, 20A, 20B, 20C and the soldered bar stock 10, 10A, 10B, 10C for forming the soldered machining tool 20, 20A, 20B, 20C as described have the following advantages.

When the soldered portion 121, 121B, 121C of the head blank 12, 12A, 12B, 12C is inserted into the first through hole 111 of the handle blank 11, 11A and is soldered to the handle blank 11, 11A, air that exists in the first through hole 111 of the handle blank 11, 11A is heated and expanded. The expanded air can be exhausted from the rear end surface of the handle blank 11, 11A. Thus, the soldered portion 121, 121B, 121C of the head blank 12, 12A, 12B, 12C and solder around the soldered portion 121, 121B, 121C will not be pushed out of the first through hole 111 by the expanded air. Accordingly, with the through hole 111 defined in the handle blank 11, 11A, the soldered portion 121, 121B, 121C of the head blank 12, 12A, 12B, 12C can be securely connected to the handle blank 11, 11A.

Moreover, when the head 22, 22A, 22B, 22C of the soldered machining tool 20, 20A, 20B, 20C wears and breaks due to long term usage, the head 22, 22A, 22B, 22C can be replaced with a new one. The end cap 13 is detached from the handle 21, 21A first, and then a portion where the head 22, 22A, 22B, 22C and the handle 21, 21A connect to each other is heated. Accordingly, the solder between the head 22, 22A, 22B, 22C and the handle 21, 21A is melted. Then, a high-pressured fluid is injected into the first through hole 111 or a pin is inserted into the first through hole 111 from the rear end surface of the handle 21, 21A to push the head 22, 22A, 22B, 22C and the solder out of the first through hole 111. Consequently, the soldered portion 121, 121B, 121C of the head 22, 22A, 22B, 22C for replacement can be firmly soldered into the first through hole 111 of the handle 21, 21A.

Furthermore, when using the first to third embodiments of the soldered machining tools 20, 20A, 20B as described, the end caps 13 can be detached from the handle 21, 21A to allow a cooling liquid to be injected into the first through hole 111 from the rear end surface of the handle 21, 21A. The cooling liquid flows out of the first through hole 111, and flows along an outer surface of the handle 21, 21A toward the head 22, 22A, 22B, 22C. Thus, the cooling liquid cools down the head 22, 22A, 22B, 22C that is heated by friction between the head 22, 22A, 22B, 22C and a workpiece. Moreover, when using the fourth embodiment of the soldered machining tool 20C, the cooling liquid further flows into and through the second through hole 123C of the head 22C to cool down the fourth embodiment of the machining tool 20C.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A soldered bar stock comprising:
a handle blank having a first through hole axially formed through the handle blank; and
a head blank securely mounted on a front end surface of the handle blank and having
a pre-machining portion; and
a soldered portion formed on and protruding from a rear end surface of the pre-machining portion, mounted into the first through hole of the handle blank, and soldered to the handle blank.

2. The soldered bar stock as claimed in claim 1 further comprising an end cap mounted on a rear end surface of the handle blank, the end cap having a connecting protrusion formed on and protruding from an end surface of the end cap, mounted into the first through hole of the handle blank, and tightly fitted in the handle blank.

3. The soldered bar stock as claimed in claim 1, wherein the head blank further has a second through hole axially formed through the pre-machining portion and the soldered portion of the head blank.

4. The soldered bar stock as claimed in claim 2, wherein the head blank further has a second through hole axially formed through the pre-machining portion and the soldered portion of the head blank.

5. The soldered bar stock as claimed in claim 1, wherein a diameter of the handle blank is different from a diameter of the pre-machining portion of the head blank.

6. The soldered bar stock as claimed in claim 4, wherein a diameter of the handle blank is different from a diameter of the pre-machining portion of the head blank.

7. The soldered bar stock as claimed in claim 1, wherein a diameter of the pre-machining portion of the head blank is equal to a diameter of the soldered portion of the head blank.

8. The soldered bar stock as claimed in claim 4, wherein a diameter of the pre-machining portion of the head blank is equal to a diameter of the soldered portion of the head blank.

9. A soldered machining tool comprising:
a handle having a first through hole axially formed through the handle; and
a head securely mounted on a front end surface of the handle and having
a machining portion; and
a soldered portion formed on and protruding from a rear end surface of the machining portion, mounted into the first through hole of the handle, and soldered to the handle.

10. The soldered machining tool as claimed in claim 9, wherein the head further has multiple helical grooves formed on an outer surface of the machining portion of the head.

11. The soldered machining tool as claimed in claim 9, wherein
the handle has
a clamping portion; and
a shank axially protruding from a front end of the clamping portion;
a diameter of the shank of the handle is shorter than a diameter of the clamping portion of the handle; and
the first through hole is axially defined through the clamping portion and the shank of the handle.

12. The soldered machining tool as claimed in claim 11, wherein
the handle further has multiple helical grooves formed on an outer surface of the shank; and
the head further has multiple helical grooves formed on an outer surface of the machining portion of the head, and respectively communicating with the helical grooves of the handle.

13. The soldered machining tool as claimed in claim 9, wherein an outer diameter of the machining portion is equal to a diameter of the soldered portion of the head.

14. The soldered machining tool as claimed in claim 10, wherein an outer diameter of the machining portion is equal to a diameter of the soldered portion of the head.

15. The soldered machining tool as claimed in claim 9, wherein the head further has a second through hole axially formed through the machining portion and the soldered portion of the head.

16. The soldered machining tool as claimed in claim 14, wherein the head further has a second through hole axially formed through the machining portion and the soldered portion of the head.

17. The soldered machining tool as claimed in claim 9 further comprising an end cap mounted on a rear end surface of the handle, the end cap having a connecting protrusion formed on and protruding from an end surface of the end cap, mounted into the first through hole of the handle, and tightly fitted in the handle.

18. The soldered machining tool as claimed in claim 12 further comprising an end cap mounted on a rear end surface of the handle, the end cap having a connecting protrusion formed on and protruding from an end surface of the end cap, mounted into the first through hole of the handle, and tightly fitted in the handle.
